(19) United States
(12) Patent Application Publication
(10) Pub. No.: US 2019/0063680 A1
(43) Pub. Date: Feb. 28, 2019

(54) STEAM TRAP AND ASEPTIC DOUBLE SEAT VALVE

(71) Applicant: EVOGUARD GMBH, Nittenau (DE)

(72) Inventor: Martin SAUER, Kaisheim (DE)

(21) Appl. No.: 16/041,102

(22) Filed: Jul. 20, 2018

(30) Foreign Application Priority Data
Aug. 30, 2017 (DE) 10 2017 215 102.1

(51) Int. Cl. F16T 1/38; B67D 1/16; B67D 1/08; B67C 7/00

(52) U.S. Cl. CPC F16T 1/383; B67C 7/0073; B67D 1/0887; B67D 1/16

(57) ABSTRACT

A steam trap is provided comprising a housing having formed therein a seat for a closure element between a steam and/or condensate inlet and an outlet, the closure element being adapted to be switched between a closed position in the seat and an open position raised from the seat, an annular gap is formed upstream of the seat in the final phase of the switching movement to the closed position and at the end position of the closed position, said annular gap being used for at least pre-filtering condensate and preventing particles from getting stuck in the seat as well as clogging of a nozzle.

### CROSS-REFERENCE TO RELATED APPLICATION

This application claims priority to German Application No. 10 2017 215 102.1 entitled “STEAM TRAP AND ASEPTIC DOUBLE SEAT VALVE,” filed on Aug. 30, 2017, the entire contents of which is hereby incorporated by reference in its entirety for all purposes.

### TECHNICAL FIELD

The present disclosure relates to a steam trap, an aseptic double seat valve, as well as a beverage filling plant.

### BACKGROUND AND SUMMARY

In the steam trap according to WO 2012/168221 A2 of an aseptic double seat valve of a filling plant for food or beverages, the valve cone has at its small-diameter end a cylindrical extension projecting, at the closed position as well as at the open position, into the outlet, which is configured as a cylindrical channel, and delimiting therein an annular flow-through space having, after the fashion of a capillary throttle, even at the open position still a length varying with the valve cone movement. The seat and the valve cone are installed such that the flow direction extends from the seat end having a large cross-section to the seat end having a small cross-section and into the outlet. The valve cone and the seat have identical taper angles, so that the seat is tightly closed at the closed position. The cross-section of the valve cone extension projecting into the outlet is only slightly smaller than the cross-section of the outlet, so that the steam pressure drop will be limited when condensate is discharged via the outlet. The leakage chamber of the double seat valve is flushed with condensate, so as to discharge contaminations and particles contained in said chamber via the steam trap, and is then sterilized with steam, so as to establish an aseptic condition at least in the leakage chamber. The drive used for switching is of a pneumatic nature.

U.S. Pat. No. 4,234,008 A discloses a non-switchable steam trap with a choke unit, in which a plurality of radial channels intersect a central axial channel, the channel cross-sections being large enough for guaranteeing the discharge of particles and foreign matter.

GB 25 12 210 A discloses a non-switchable steam trap used for a pipeline and including a fixed throttle, said fixed throttle being preceded by an upstream mechanical filter used for restraining particles and contaminations and adapted to be removed for the purpose of cleaning.

DE 10 2016 203 557 A, which has a prior time rank, suggests a steam trap of an aseptic double seat valve, in which e.g. the valve cone comprises at least one control notch defining, even at the closed position, a two-part nozzle as a result of the interaction of the seat and of the valve cone. The valve cone is defined by a truncated cone whose small-diameter end extends at the closed position approximately into the cylindrical inlet. The entire disclosure of DE 10 2016 203 557 A is herewith incorporated by reference, since this publication discloses information on structural features and functions of such steam traps, which contributes to the intelligibility of the present invention.

It is the object of the present disclosure to provide a steam trap, an aseptic double seat valve and a beverage filling plant, which are characterized by an improved operating behavior and reduced maintenance and cleaning frequencies. In particular, the steam trap should, during operation, be largely resistant to particles entrained by the condensate/steam

This object is achieved by a steam trap, in particular for aseptic double seat valves in beverage or food filling plants, comprising a housing having formed therein a seat for a closure element between a steam and/or condensate inlet and an outlet, the closure element being adapted to be switched by means of a drive between a closed position in the seat and an open position raised from the seat, wherein at least at the end position of the closed position, an annular gap is formed upstream of the seat in a flow direction of steam and/or condensate from the inlet into the outlet, said gap for preventing particles from getting stuck in the seat as well as clogging of a nozzle that is formed between the closure element and the seat, the gap being formed by a distance of the closure element from the housing; and by an aseptic double seat valve of a beverage or food filling plant; and by a beverage filling plant with the valve and the steam trap.

Through the gap, in particular the annular gap, which is formed upstream of the seat in the inlet as a prefilter and which is approximately linear in shape and has always the same effective length in the flow direction, a geometrically defined passage is created in the flow of the condensate and/or of the steam, said passage being, however, especially only effective in the final phase of the closing switching movement, but in any case at the closed position of the valve cone, however, not during the residual stroke of the switching movements, in the course of which the prefilter is automatically cleaned.

The gap need not necessarily be ring-shaped. When the term annular gap is used hereinafter, also other geometrical shapes are comprised. Advantageously, however, the annular gap is ring-shaped.

At the closed position of the valve cone, the annular gap prevents clogging of a possibly provided control notch, this being of the utmost importance for the function of the steam trap. In the final phase of the closing switching movement, the annular gap also prevents particles having a size that exceeds the width of the annular gap from penetrating into the seat and from getting stuck between the valve cone and the seat, where they would impair the correct function of the steam trap. This also guarantees that the predetermined closed position of the valve cone will reliably be reached. Thus, the steam trap can be operated in a trouble-free manner with a substantially longer service life, intermediate cleaning being, however, possible at any time by widely opening the passage.

The aseptic double seat valve equipped with a steam trap according to the present disclosure is characterized by a long service life and reliable flushing and sterilizing cycles, an aseptic condition of at least the leakage chamber being guaranteed after each flushing and sterilizing cycle.

According to an expedient embodiment, the annular gap is delimited with a substantially constant width by an undercut annular flange in the small-diameter end region of the valve cone and by the inlet, which is configured as a cylindrical extension of the small-diameter end of the seat. In other words, the annular gap is defined by the distance between the valve cone end and the hollow inlet at the closed position, the hollow inlet surrounding the valve cone end preferably in an annular shape. Due to the fact that the diameter of the valve cone end is slightly smaller than the inlet, the distance is defined. Hence, the annular gap is easily accomplished as regards production technology and is integrated in the steam trap in a functionally simple manner making use of known structural features.

According to a further important aspect of the present invention, a circumferential annular flow space extending, at least substantially, parallel to the annular gap is provided, when seen in the flow direction, adjacent to the annular gap and downstream of the annular gap, preferably in the valve cone. This circumferential annular flow space can especially be used for guiding condensate, when the latter has passed the annular gap, from the entire circumference to a control notch under very advantageous flow conditions.

According to an advantageous embodiment, the undercut of the annular flange is formed by a circumferential groove provided in the valve cone and defining the annular flow space. This is advantageous as regards production technology and allows the annular flange, which defines the annular gap, to be formed precisely on the valve cone such that advantageous flow conditions will be provided.

With respect to perfect flow conditions in the area of the annular gap, it will be expedient to provide the cross-sections of the annular flange and of the circumferential groove with a convex curvature and a concave curvature, respectively.

According to an advantageous embodiment, the valve cone with the annular flange and the circumferential groove is adapted to the seat such that, at the closed position, an edge of the circumferential groove in the valve cone is located approximately on the level of the small-diameter end of the seat, said edge facing away from the annular flange. In this way, a certain stroke length of the initial phase and of the final phase of the switching movement of the valve cone is predetermined, within which the annular gap is effective as a prefilter.

According to a further important aspect of the present invention, a sealing face of the valve cone or/and a seating area of the seat have provided therein a control notch at at least one circumferential position, said control notch extending substantially parallel to the cone axis. This control notch may e.g. be an approximately partially cylindrical milled-out portion. The control notch begins in the edge of the circumferential groove and defines, at the closed position, an open, two-part nozzle. The circumferential groove provided downstream of the annular gap in the valve cone allows an unimpaired flow of condensate to the nozzle from the entire circumference of the annular gap. Through the structural design and the arrangement of the annular gap, particles, which may clog the nozzle, are prevented from arriving at the nozzle and from clogging the same. Since the circumferential length of the filter gap is a multiple of the nozzle width, a very large number of particles can there accumulate in front of the annular gap before a complete closure of the annular gap will occur. When the annular gap is delimited on the inner side thereof by the movable valve cone, the annular gap will be opened in the case of each opening switching movement of the valve cone and cleaned intensively. This also applies to the control notch. The annular gap also prevents, in the final phase of the closing switching movement of the valve cone, larger particles from getting stuck between the valve cone and the seat, which particles would impair the aimed-at effect of the nozzle, since the formation of the annular gap already starts before the valve cone enters into contact with the seat, i.e. as long as the space between the valve cone and the seat is still large enough for discharging, with the flow, larger particles, which may have entered up to this moment in time, into the outlet.

In the case of this switchable steam trap provided with the control notch, it would not make sense to arrange a conventional mechanical prefilter, since, when the steam trap has been switched to the open condition, the full free cross-section of the inlet must be open for rapidly discharging condensate and product residues in the flushing cycle. In addition, a conventional prefilter through which a flow passes permanently would be clogged by product residues and particles during the flushing cycle within a short period of time, and this would result in uncontrollable hygienic conditions. On the other hand, if no prefilter were provided, the nozzle would easily be clogged e.g. during a sterilization cycle by still existing residual contaminations from the flushing cycle, so that frequent cleaning cycles would have to be incorporated by control, and this, in turn, would significantly increase the sterilization time and the consumption of steam. The annular gap opening automatically as a prefilter does, however, not exhibit these technical drawbacks.

According to an expedient embodiment, a two-part nozzle can be formed by means of the at least one control notch. Starting from the circumferential groove in the valve cone, said nozzle first defines a constriction, when seen in the flow direction, and increases in width subsequently.

For configuring the seat and the valve cone, two concepts are possible. It is either possible to provide identical taper angles, or the taper angle of the valve cone may be slightly smaller, e.g. by 1° to 5°, than the taper angle of the seat. If the taper angles of the seat and of the valve cone are identical, the control notch will extend from the circumferential groove up to the large-diameter end of the seat and of the valve cone, respectively. If the taper angle of the valve cone is, however, smaller, the control notch may already end at a distance from the large-diameter end of the seat and of the valve cone, respectively, since the sealing face of the valve cone is there spaced apart from the seating area of the seat.

In addition, it will be expedient, if, in the housing, the respective small-diameter end of the seat and of the valve cone are positioned upstream of the respective large-diameter end, when seen in the flow direction, since the flow passing therethrough will expand optimally in this way.

According to an expedient embodiment, the width of the annular gap is smaller than the radial depth of the nozzle, which is defined by the control notch, at the narrowest point, so that particles having a size that exceeds the width of the annular gap will not arrive at the control notch. The width may especially range from approximately 0.1 to 0.4 mm.

In other words, the width of the annular gap (distance between the valve cone and the housing) is, at the closed position, smaller than the largest width between the valve cone and the seating area in the region of the nozzle (measured in the direction of the normal onto the seating area).

According to another important idea of the present invention, the cross-sectional area of the annular gap is a multiple of the narrowest cross-section of the control notch and of the nozzle, respectively. The cross-sectional area of the annular gap may e.g. be about twelve times as large.

The gist of the present disclosure is to be seen in the integrated annular gap, which, at the closed position and in particular during the closing switching movement, forms an efficient mechanical prefilter on the inlet side and which is automatically cleaned, without intervention from outside, by the movement of the valve cone alone.

The present disclosure also relates to a beverage filling plant with a valve, which comprises the steam trap. In addition to a beverage filling machine, in particular a beverage filling machine of the rotary type, the beverage filling plant may also comprise other components, such as a mixer for beverages, a CIP plant, a short-time heating unit and/or a degasser, through which the beverage or components thereof flow. By means of a valve comprising the steam trap and/or by means of a plurality of such valves, the flows can be interrupted, released or rerouted at certain points. The valve is connected to the above-mentioned components especially via pipes.

### BRIEF DESCRIPTION OF THE DRAWINGS

Making reference to the drawing, embodiments of the present disclosure will be explained, in the case of which:

FIG. 1 shows a longitudinal section of the steam trap at the closed position.

FIG. 2 shows, on an enlarged scale, a detail emphasized in FIG. 1 by a circle.

FIG. 3 shows a perspective view of a valve cone of the steam trap.

FIG. 4 shows a longitudinal section of the steam trap at the end of the initial phase of an opening switching movement and at the beginning of a final phase of the closing switching movement, respectively.

FIG. 5 shows, on an enlarged scale, a detail emphasized in FIG. 4 by a circle.

FIG. 6 shows a longitudinal section of the steam trap at the open position of the valve cone.

### DETAILED DESCRIPTION

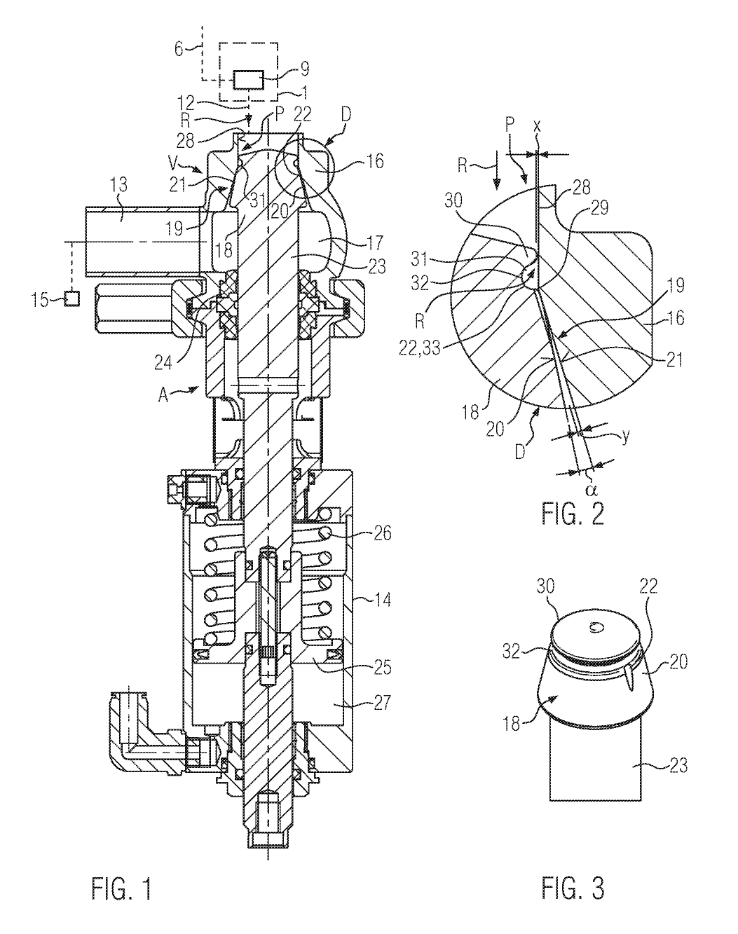

FIG. 1 to FIG. 6 show a steam trap A, which may be adapted to be combined with a double seat valve 1 of a food or beverage filling plant (not shown), but which may also be used for other intended purposes, where a heated gaseous medium, such a steam, is processed. The steam trap A corresponds largely to the steam trap described in DE 10 2016 203 557 A, which has a prior time rank and which is herewith incorporated by reference.

In the case shown as a non-limiting example, the steam trap A is connected via an inlet 12 (inlet line) to a leakage chamber 9 of the double seat valve 1, at least the leakage chamber 9 having supplied thereto steam and/or condensate for flushing and sterilization cycles via a line 6.

The steam trap A in FIG. 1 comprises a housing 16 delimiting a valve chamber 17 and comprising a seat 19 with a conical seating area 21 for a conical sealing face 20 of a valve cone 18. The seat 19 conically increases in width from the inlet 12 in the flow direction R towards the valve chamber 17, which is connected to the outlet 13 that may be connected e.g. to an impact absorber 15 for collecting condensate and contaminations. At the closed position shown in FIG. 1, the valve cone 18 extends substantially fully into the seat 19 from below, so that the sealing face 20 and the seating area 21 as a seat valve would sealingly shut off the passage in the flow direction R from the inlet 12 to the outlet 13. However, the valve cone 18 and the seat 19 define, at the closed position shown, with at least one control groove 22 a two-part nozzle D, through which a limited flow (e.g. for a sterilization cycle) is given even at the closed position. In the embodiment shown, the control groove 22 is formed in the sealing face 20, e.g. as a partially cylindrical milled-out portion. The nozzle D formed by the control groove 22 at the closed position defines, in the flow direction R, a constriction and increases in width subsequently.

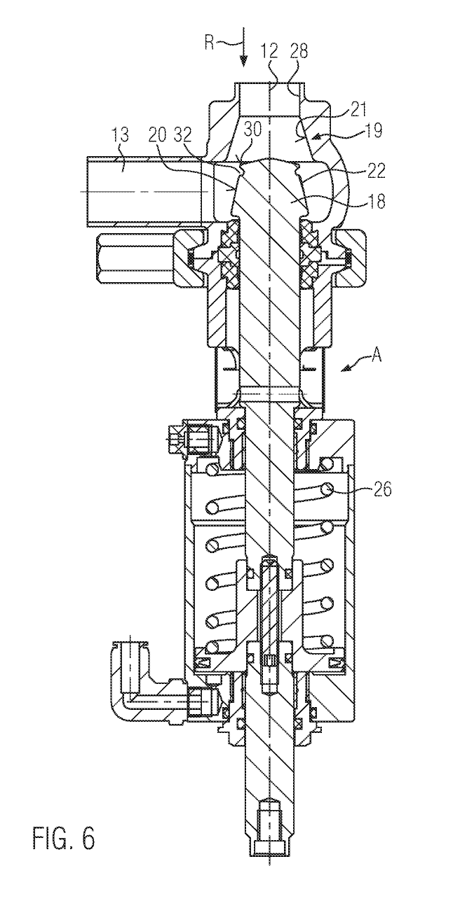

The valve cone 18 is arranged on a stem 23, which is connected to a piston 25 of a drive 14 and which is adapted to be acted upon by a pressure fluid in a chamber 27, so as to adjust the closed position shown in FIG. 1. In the opposite direction, a spring 26 is effective, said spring 26 adjusting an open position of the steam trap A (FIG. 6). The stem 23 is sealed off from the valve chamber 17 by means of a seal 24.

In the case of an alternative, which is not shown, the control groove 22 may be arranged in the seating area 21 of the seat 19, or circumferentially aligned control grooves may be provided in the seating area 21 as well as in the sealing face 20. Furthermore, a plurality of control grooves 22, which are distributed in the circumferential direction, may be provided.

The inlet 12 is configured as a cylindrical extension 28 of the small-diameter end of the seat 19 and such that it has the diameter of the latter and it forms, together with an annular flange 30 provided on the end of the valve cone 18, a circumferentially extending annular gap P of constant width (e.g. from 0.2 up to 0.4 mm) at the closed position shown, said annular gap P being only formed as long as the small-diameter end of the valve cone 18 with the annular flange 30 extends into the cylindrical extension 28 during the opening and closing switching movements of the valve cone 18. The valve cone 18 has formed therein, adjacent to the annular gap P when seen in the flow direction R, an annular flow space 31, e.g. a circumferential groove 32 (FIG. 2), which extends substantially parallel to the annular gap P and in which the nozzle D begins.

The steam trap A with the annular gap P may also be operated without the control groove 22.

In the embodiment according to FIGS. 1 and 2, the seat 19 and the valve cone have different taper angles, i.e. the taper angle of the sealing face 20 of the valve cone 18 is smaller by an angle a than the taper angle of the seating area 21 of the seat 19. The difference between these angles may range from approx. 1° to 4°. This has the effect that, when the sealing face 20 at the small-diameter end of the valve cone 18 abuts on the seating area 21 at the small-diameter end of the seat 19, an open space will be created in the flow direction R, into which the nozzle D opens, said nozzle D extending, according to FIG. 3, only from an edge 33 of the circumferential groove 32 over part of the axial height of the sealing face 20. The nozzle D has a cross-section which first narrows in the flow direction R and it increases in width, e.g. with the open space, from the narrowest point onwards.

According to an alternative embodiment, which is not shown, the taper angles of the valve cone 18 and of the seat 19 may be identical. In this case, the control groove 22 (in the sealing face 20 or in the seating area 21 or in both said components) extends up to the large-diameter end of the sealing face 20 or of the seating area 21. The respective taper angle may be between approx. 30° and 60°, and is optionally an angle of approx. 40° (tip angle).

The annular gap P is delimited by the annular flange 30 at the small-diameter end of the valve cone 18 and by the inner wall of the cylindrical extension 28. The annular flange 30 may be undercut by the circumferential groove 32, contours having a rounded cross-section and a rounded transition being here expedient. At the closed position shown in FIGS. 1 and 2, the edge 33 of the circumferential groove 32 is located approximately on the level of the small-diameter end 29 of the seating area 21 of the seat 19. The nozzle D has, at the closed position, a radial width Y that is larger than the width X of the annular gap P.

In FIG. 3 only one control groove 22 is shown on the valve cone 18 at a circumferential position. Alternatively, more than one control groove may be distributed in the circumferential direction.

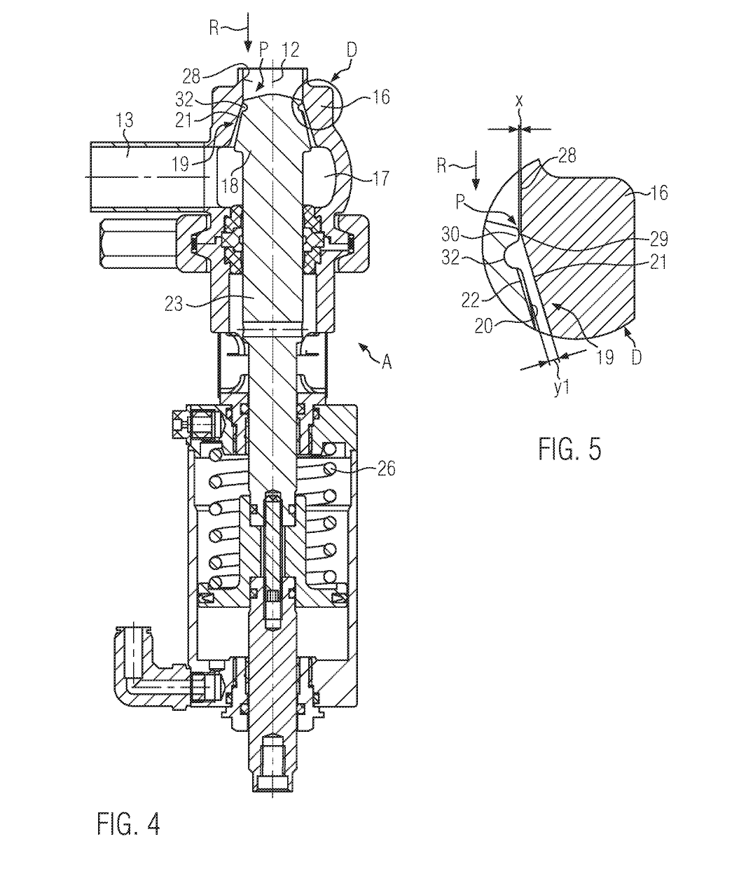

FIG. 4 shows the steam trap A at a position corresponding to the beginning of a final phase of a closing switching movement of the valve cone 18, i.e. a flow through the annular gap P is possible, which serves to flush the valve seat before the valve seat is finally closed. This flowthrough is much higher than the flowthrough at the closed position in FIG. 1, but much lower than the flowthrough at the open position in FIG. 6.

In the case of a further alternative, which is not shown, the control groove 22 may be omitted, so that the annular gap P alone determines the flowthrough between the positions according to FIG. 1 and FIG. 4.

FIG. 5 illustrates, on an enlarged scale, a detail emphasized in FIG. 4 by a circle. The annular flange 30, which delimits the annular gap P with the cylindrical extension 28 and the width X, is located approximately on the level of the small-diameter end 29 of the seat 19, whereas the circumferential groove 32 is located below the small-diameter end 29. The control groove 22 is, in the sealing face 20, already located at a considerable distance Y1 from the seating area 21, said distance Y1 being a multiple of the width X, e.g. twelve times the width X.

At the open position of the steam trap A shown in FIG. 6 and switched by the spring 26, the valve cone 18 has been pulled out of the seat 19 approximately down to the large-diameter end of the seat 19, so that a large flow cross-section corresponding approximately to the cross-sections of the cylindrical extension 28 and of the outlet 13 is open.

The annular gap P serves a dual purpose: at the closed position according to FIG. 1, the annular gap P prevents particles contained in the condensate/steam and having a size larger than the width X of the annular gap P from entering the nozzle D and the seat 19, respectively. In this way, clogging of the nozzle D will be prevented. In the final phase of the closing switching movement of the valve cone (between FIG. 5 and FIG. 2), the annular gap P prevents larger particles from penetrating between the sealing face 20 and the seating area 21, where they might get stuck and obstruct or prevent the reaching of the closed position according to FIG. 1 and clog the nozzle D. The flow passing through the annular gap P flows into the circumferential groove 32 from all sides and from said circumferential groove 32 to the nozzle D and the outlet 13.

Since the circumferential length of the annular gap P is a multiple of the nozzle width, many particles can accumulate along the annular gap P before the annular gap P will be blocked completely. When the opening switching movement of the valve cone 18 has started and when the annular flange 30 is being pulled out of the seat 19, a large flow cross-section will open, so that fast flowing condensate will intensively clean the nozzle D and the control groove 22 (if there is one), the seating area 21 and the sealing face 20. In the case of clogging, a controlled intermediate cleaning step may be carried out, e.g. by pulling the valve cone 18 towards the position according to FIG. 6 for a short period of time, and, when contaminations have been flushed out, by returning the valve cone 18 to the closed position or the position according to FIG. 4. During the closing switching movement of the valve cone 18, the annular gap P prevents larger particles from getting stuck in the seat 19, since the annular gap P already becomes effective before the valve cone 18 enters into contact with the seat 19 and since, in this phase, the space between the valve cone 18 and the seat 19 is still large enough for discharging penetrating particles having a size larger than the width X of the annular gap P outwards to the outlet 13.

The closed position shown in FIG. 1 is switched, e.g. during a sterilization cycle with steam, e.g. in the leakage chamber 9 of the double seat valve 1, whereas the open position shown in FIG. 6 belongs to a flushing cycle in the course of which the leakage chamber 9 is cleaned with liquid condensate or with a mixture of condensate and steam.

1. A steam trap comprising a housing having formed therein a seat for a closure element between a steam and/or condensate inlet and an outlet, the closure element being adapted to be switched by a drive between a closed position in the seat and an open position raised from the seat, wherein at least at the end position of the closed position, an annular gap is formed upstream of the seat in a flow direction of steam and/or condensate from the inlet into the outlet, said gap for preventing particles from getting stuck in the seat as well as clogging of a nozzle that is formed between the closure element and the seat, the gap being formed by a distance of the closure element from the housing.

2. The steam trap according to claim 1, wherein the gap is delimited with a substantially constant width by an undercut annular flange in a small-diameter end region of the closure element, which is configured as a valve cone, and by the inlet, which is configured as an axial, cylindrical extension of a small-diameter end of the seat, the annular flange and the extension having identical contours and being circular or polygonal.

3. The steam trap according to claim 1, wherein a circumferential annular flow space extending, at least substantially, parallel to the annular gap is provided, when seen in the flow direction, downstream of the annular gap and substantially adjacent to the annular gap, in the closure element configured as a valve cone.

4. The steam trap according to claim 2, wherein the undercut of the annular flange is formed by a circumferential groove provided in the valve cone and defining an annular flow space.

5. The steam trap according to claim 4, wherein when seen in cross-section, the annular flange has a convex curvature and the circumferential groove has a concave curvature with a rounded transition, and that the seat and the valve cone have frusto-conical circumferential surfaces as a seating area and as a sealing face.

6. The steam trap according to claim 4, wherein at the closed position, an edge of the circumferential groove is located approximately on the level of the small-diameter end of the seat, said edge facing away from the annular flange.

7. The steam trap according to claim 6, wherein a sealing face of the valve cone or/and a seating area of the seat have provided therein at least one control notch at least at one circumferential position, said control notch extending parallel to the cone axis and beginning in the edge of the circumferential groove; and wherein the control notch is an approximately partially cylindrical milled out portion.

8. The steam trap according to claim 7, wherein by means of the at least one control notch, a two-part nozzle is formed at least at the closed position, said nozzle beginning, when seen in the flow direction, at the circumferential groove and increasing in width subsequently.

9. The steam trap according to claim 7, wherein the control notch extends up to a large-diameter end of the seat and of the valve cone, respectively, when the seat and the valve cone have identical taper angles, whereas it ends at a distance from the large-diameter end of the seat and of the valve cone, respectively, if the taper angle of the valve cone is smaller than the taper angle of the seat.

10. The steam trap according to claim 9, wherein in the housing, the small-diameter end of the seat and of the valve cone are positioned upstream of the respective large-diameter end, when seen in the flow direction.

11. The steam trap according to claim 8, wherein a gap width of the annular gap is smaller than a radial depth of the control notch at a narrowest point of the nozzle.

12. The steam trap according to claim 7, wherein a cross-sectional area of the annular gap is a multiple of the narrowest cross-section of the control notch and of the nozzle, respectively.

13. An aseptic double seat valve of a beverage or food filling plant, comprising a leakage chamber, which is adapted to be flushed with condensate and to be sterilized with steam, wherein the double seat valve comprises a switchable steam trap comprising a housing having formed therein a seat for a closure element between a steam and/or condensate inlet and an outlet, the closure element being adapted to be switched by means of a drive between a closed position in the seat and an open position raised from the seat, wherein at least at the end position of the closed position, an annular gap is formed upstream of the seat in a flow direction of steam and/or condensate from the inlet into the outlet, said gap for preventing particles from getting stuck in the seat as well as clogging of a nozzle that is formed between the closure elements and the seat, the gap being formed by a distance of the closure element from the housing wherein the inlet is connected to the leakage chamber.

14. A beverage filling plant comprising a valve, which comprises a steam trap comprising a housing having formed therein a seat for a closure element between a steam and/or condensate inlet and an outlet, the closure element being adapted to be switched by means of a drive between a closed position in the seat and an open position raised from the seat, wherein characterized in that at least at the end position of the closed position, an annular gap used for pre-filtering condensate is formed upstream of the seat in a flow direction of the steam and/or condensate from the inlet into the outlet, said gap for preventing particles from getting stuck in the seat as well as clogging of a nozzle that is adapted to be formed between the closure elements and the seat, the gap being formed by a distance of the closure element from the housing.

15. The steam trap according to claim 1, wherein the steam trap is for aseptic double seat valves in beverage or food filling plants.

16. The steam trap according to claim 1, wherein the annular gap is used for at least pre-filtering the condensate.

17. The steam trap according to claim 11, wherein the annular gap ranges from approximately 0.1 to 0.4 mm.

18. The steam trap according to claim 12, wherein the multiple of the narrowest cross-section is about twelve.
